(19) United States
(12) Patent Application Publication
(10) Pub. No.: US 2025/0106589 A1
(43) Pub. Date: Mar. 27, 2025

(54) INFORMATION PROCESSING DEVICE

(71) Applicant: TOYOTA JIDOSHA KABUSHIKI KAISHA, Toyota-shi (JP)

(72) Inventors: Katsuhiro MATSUOKA, Nagakute-shi (JP); Hidenori AKITA, Toyota-shi (JP); Ryo TAMURA, Toyota-shi (JP)

(73) Assignee: TOYOTA JIDOSHA KABUSHIKI KAISHA, Toyota-shi (JP)

(21) Appl. No.: 18/790,203

(22) Filed: Jul. 31, 2024

(30) Foreign Application Priority Data
Sep. 22, 2023 (JP) 2023-159266

(51) Int. Cl. H04W 4/02; G08G 1/16; H04B 17/318; H04W 4/40

(52) U.S. Cl. CPC H04W 4/025; G08G 1/167; H04B 17/318; H04W 4/40

(57) ABSTRACT

The information processing device acquires current positions of a plurality of vehicles. Further, the information processing device estimates an intensity distribution of radio waves output by each of the plurality of vehicles according to a current position of the plurality of vehicles. In addition, the information processing device acquires the reception intensity of the radio wave output by each of the plurality of vehicles received by the terminal moving together with the user. Then, the information processing device specifies a position where the intensity distribution and the reception intensity correspond to each other as a current position of the user.

### CROSS-REFERENCE TO RELATED APPLICATION

This application claims priority to Japanese Patent Application No. 2023-159266 filed on Sep. 22, 2023, incorporated herein by reference in its entirety.

### BACKGROUND

### 1. Technical Field

The present disclosure relates to an information processing device.

### 2. Description of Related Art

Japanese Unexamined Patent Application Publication No. 2013-156703 (JP 2013-156703 A) discloses a device that provides blind spot information. In the providing device disclosed in JP 2013-156703 A, position information of a vehicle and position information of a vehicle exterior object are input. In addition, information on a blind spot range of a driver of the vehicle is input to the providing device. The providing device detects a relative position between the vehicle and the vehicle exterior object based on the position information of the vehicle and the position information of the vehicle exterior object. Further, the providing device recognizes the information of the blind spot range, grasps the detected relative position, and recognizes whether the vehicle exterior object has entered the blind spot range based on the grasping result. Then, the providing device provides the recognized information to the vehicle exterior object when it is recognized that the vehicle exterior object has entered the blind spot range.

### SUMMARY

An object of the present disclosure is to provide a technique capable of grasping an accurate present position of a user.

An aspect of the present disclosure provides an information processing device including a control unit configured to:
acquire a present position of a plurality of vehicles;
estimate an intensity distribution of a radio wave output by each of the vehicles according to the present position of the vehicles;
acquire a reception intensity of the radio wave output by each of the vehicles and received by a terminal that moves together with a user; and
specify a position corresponding to the intensity distribution and the reception intensity as a present position of the user.

According to the present disclosure, it is possible to grasp an accurate present position of a user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a position specifying system;

FIG. 2 is a diagram illustrating an example of an intensity distribution of radio waves output from two vehicles;

FIG. 3 is a block diagram schematically illustrating an example of a functional configuration of a server;

FIG. 4 is a diagram illustrating an exemplary table configuration of user information held in a user information database; and

FIG. 5 is a flowchart of processing executed by the control unit.

### DETAILED DESCRIPTION OF EMBODIMENTS

Assume a case where the current position of the user is to be grasped. At this time, a current position acquired by a terminal that moves together with a user (hereinafter, may be simply referred to as a “terminal”) may be inaccurate. In addition, the terminal may not be able to acquire the current position. Then, it is assumed that it is difficult to grasp the current position of the user. An information processing device according to the present disclosure solves such a problem.

The control unit of the information processing device according to the present disclosure acquires current positions of a plurality of vehicles. Here, radio waves that can be received by the terminal are output from a plurality of vehicles. The control unit of the information processing device estimates an intensity distribution of radio waves output by each of the plurality of vehicles according to a current position of the plurality of vehicles. In addition, the control unit acquires the reception intensity of the radio wave output by each of the plurality of vehicles received by the terminal. At this time, since the control unit grasps the intensity distribution, it is possible to grasp the reception intensity of the radio wave received from each vehicle by the terminal at each point. Therefore, the control unit specifies the position where the intensity distribution and the reception intensity correspond to each other as the current position of the user.

As described above, even when the current position acquired by the terminal is inaccurate or the terminal cannot acquire the current position, it is possible to grasp an accurate current position of the user by using the intensity distribution and the reception intensity.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### Embodiment

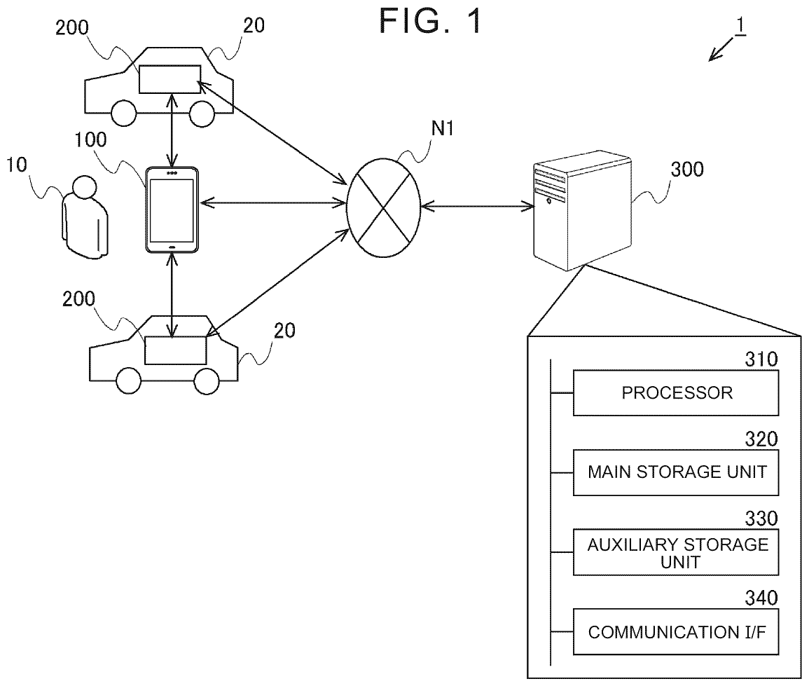

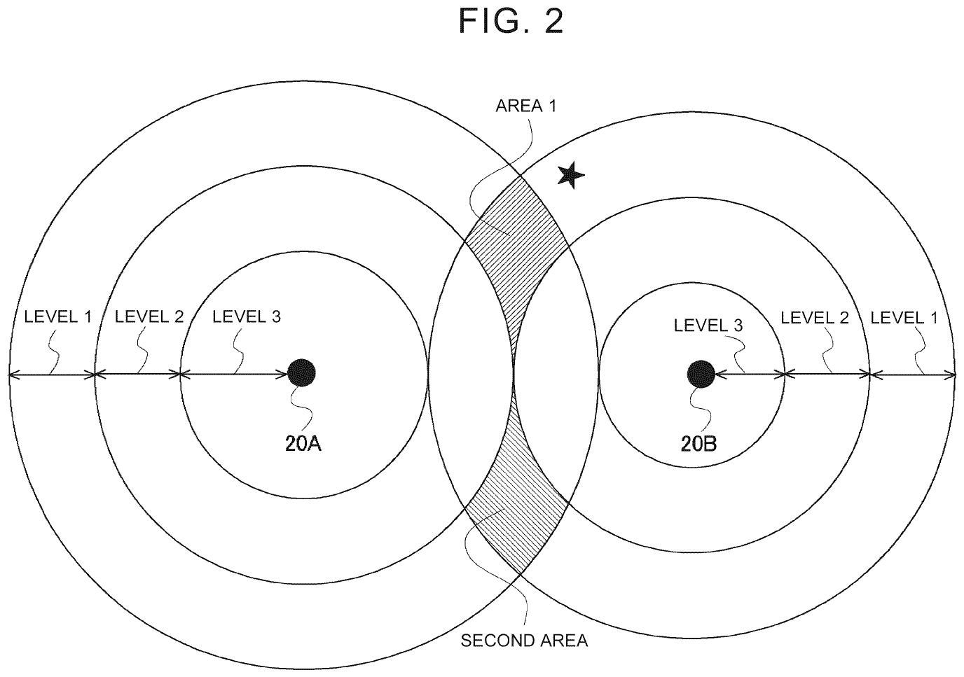

The position specifying system 1 will be described with reference to FIG. 1 to FIG. 2. FIG. 1 is a diagram illustrating a schematic configuration of a position specifying system 1. The position specifying system 1 includes a user terminal 100, a plurality of in-vehicle terminals 200, and a server 300.

In the position specifying system 1, a user terminal 100, a plurality of in-vehicle terminals 200, and a server 300 are connected to each other by a network N1. The network N1 may employ, for example, a Wide Area Network (WAN) which is a global public communication network such as the Internet, or a telephone communication network such as a cellular telephone. Further, in the position specifying system 1, the user terminal 100 is capable of receiving radio waves used by each in-vehicle terminal 200 for short-range communication. The short-range communication is, for example, communication such as Wi-Fi (registered trademark) or Bluetooth (registered trademark).

### User Terminal

The user terminal 100 is a terminal that moves together with the user 10. Examples of the user terminal 100 include a portable information terminal used by the user 10. That is, the current position of the user terminal 100 normally matches the current position of the user 10. Here, the user 10 may exist in a building. As a result, the user terminal 100 may not be able to receive GPS radio wave, and the present position that can be acquired by GPS device may be inaccurate. Therefore, it may be difficult for the user terminal 100 to acquire an accurate current position of the user 10 (the user terminal 100). Therefore, it is not possible to directly use the current position of the user terminal 100 measured by the user terminal 100 to grasp an accurate current position of the user 10.

The user terminal 100 transmits, via the network N1, location data indicating the present location of the user terminal 100 measured by the user terminal 100 to the server 300. Details of how the server 300 uses the current location of the user terminal 100 as measured by the user terminal 100 will be described later.

In addition, the user terminal 100 is capable of receiving radio waves for short-range communication output from the plurality of in-vehicle terminals 200. At this time, the user terminal 100 transmits, to the server 300 in real time, information (hereinafter, sometimes referred to as “reception intensity information”) indicating the reception intensity of a radio wave for performing direct communication with each in-vehicle terminal 200. Details of the reception intensity information received by the server 300 from the user terminal 100 will be described later.

### In-Vehicle Terminal

The in-vehicle terminal 200 is a device mounted on the vehicle 20. Here, the vehicle 20 exists in the same building as the building in which the user 10 exists (hereinafter, sometimes referred to as “specific building”). Further, the in-vehicle terminal 200 acquires the current position of the vehicle 20. The in-vehicle terminal 200 acquires the present position of the vehicle 20 using GPS method. Then, the in-vehicle terminal 200 transmits the position information indicating the present position of the vehicle 20 to the server 300 via the network N1.

Here, the in-vehicle terminal 200 can specify the current position of the vehicle 20 by the camera included in the vehicle 20. In this case, the in-vehicle terminal 200 identifies the current position of the vehicle 20 in the specific building by referring to the feature point in the specific building or the like in the image data acquired by the camera included in the vehicle 20. Further, the in-vehicle terminal 200 may acquire the current position of the vehicle 20 by using a positioning system provided in a specific building or the like. In addition, the in-vehicle terminal 200 may have a higher GPS system than GPS system of the user terminal 100, and may be configured so as to be able to acquire the present position of the vehicles 20 even in a particular building. As described above, the in-vehicle terminal 200 can acquire the current position more accurately than the user terminal 100 in the specific building.

### Server

The server 300 is a server that specifies the current location of the user 10. Here, as described above, the server 300 receive position information indicating the present position of the vehicles 20 from the in-vehicle terminals 200 via the network N1. Further, the server 300 receives, from the user terminal 100, the position information indicating the present position of the user terminal 100 acquired by the user terminal 100 via the network N1. Here, it is assumed that the current position of the vehicle 20 received by the server 300 is more accurate than the current position of the user terminal 100.

Therefore, the server 300 refers to the current positions of the plurality of vehicles 20 (in-vehicle terminals 200) and estimates the intensity distribution of the radio waves for short-range communication output from each in-vehicle terminal 200. Specifically, the server 300 estimates (calculates) the intensity distribution of the radio wave output from the current position of each vehicle 20 (the in-vehicle terminal 200) using the map information in the specific building. The server 300 calculates an intensity distribution in accordance with an attenuation amount when a radio wave is output from the current position of each vehicle 20. In addition, the server 300 calculates the intensity distribution of the radio waves output from each in-vehicle terminal 200 in consideration of reflection of the radio waves by a structure such as a wall or a column in the specific building. Further, it is assumed that radio waves are reflected by the vehicle 20 in the specific building. Therefore, the server 300 may calculate the intensity distribution of the radio waves output from the respective in-vehicle terminals 200 in consideration of the reflection of the radio waves or the like expected due to the presence of the plurality of vehicles 20 at the current position. 30

Further, the server 300 receives the reception strength information from the user terminal 100. At this time, since the server 300 grasps the intensity distribution of the radio waves output from each in-vehicle terminal 200, it is possible to grasp the reception intensity of the radio waves received from each in-vehicle terminal 200 when the user terminal 100 is present at each point. Therefore, the server 300 identifies the current position of the user 10 with reference to the reception intensity indicated by the reception intensity information and the intensity distribution of the radio wave output from each in-vehicle terminal 200.

Specifically, the server 300 specifies, for each in-vehicle terminal 200, an area in which the intensity distribution and the reception intensity correspond to each other. That is, the server 300 specifies an area corresponding to the intensity distribution of one in-vehicle terminal 200 and the reception intensity of the in-vehicle terminal 200. Then, the server 300 identifies, as the current position of the user 10, an area that is common in the area in which the intensity distribution and the reception intensity correspond to each other for each in-vehicle terminal 200.

FIG. 2 is a diagram illustrating an example of an intensity distribution of radio waves output from two vehicles 20. FIG. 2 shows a state in which radio waves are outputted from two vehicles 20 (vehicle 20A and vehicle 20B) in a specified building. In the embodiment illustrated in FIG. 2, radio waves are distributed at levels 3, 2, and 1, respectively, with the vehicle 20A and the vehicle 20B as the center. Here, the radio wave intensity of level 3 is the strongest radio wave intensity, the weakest radio wave intensity of level 1. As described above, in the embodiment illustrated in FIG. 2, the closer the vehicle 20A (vehicle 20B) is to the closer, the more powerful radio waves are received by the user terminal 100.

Here, it is assumed that the user terminal 100 receives a radio wave from the in-vehicle terminal 200 on the vehicle 20A with a reception intensity of level 1 and the user terminal 100 receives a radio wave from the in-vehicle terminal 200 on the vehicle 20B with a reception intensity of level 1. In this case, it is assumed that the user 10 exists in the first area or the second area illustrated in FIG. 2.

In addition, the server 300 receives position information indicating the current position of the user terminal 100 from the user terminal 100. Here, the current position of the user terminal 100 in the position information received from the user terminal 100 may be inaccurate. However, the location information received from the user terminal 100 is considered to indicate a rough current location of the user terminal 100, although it is not the current location of the complete user terminal 100. Therefore, when the position information received from the user terminal 100 indicates the position of the asterisk shown in the example shown in FIG. 2, it can be assumed that the user 10 is highly likely to exist in the first area. Therefore, the server 300 specifies that the current position of the user 10 is within the first area.

In the example illustrated in FIG. 2, two vehicles 20 are present, but two or more vehicles 20 may be present in a specific building. In this case, the server 300 identifies the current position of the user 10 by referring to the intensity distribution of the radio waves output by the in-vehicle terminal 200 in the two or more vehicles 20 and the reception intensity of the radio waves output by the in-vehicle terminal 200 in the two or more vehicles 20.

Further, the server 300 refers to the current position of the user 10 and the current position of the vehicle 20, and determines whether or not the user 10 and the vehicle 20 are within a predetermined distance. The predetermined distance is set to a distance that is assumed to cause a danger to the user 10 and the vehicle 20. The server 300 transmits notification information to the user terminal 100 and the in-vehicle terminal 200 when the user 10 and the vehicle 20 are within a predetermined distance. Here, the notification information transmitted to the user terminal 100 is information for notifying that attention is necessary for the vehicle 20 to exist around the user 10. In addition, the notification information transmitted to the in-vehicle terminal 200 is information notifying that attention is necessary for the user 10 to exist around the vehicle 20.

The server 300 is configured to include a processor 310, a main storage unit 320, an auxiliary storage unit 330, and computers having communication interfaces (communication I/F) 340. The processor 310 is, for example, Central Processing Unit (CPU) or Digital Signal Processor (DSP). The main storage unit 320 is, for example, a Random Access Memory (RAM). The auxiliary storage unit 330 is, for example, a Read Only Memory (ROM). The auxiliary storage unit 330 is, for example, a Hard Disk Drive (HDD), a CD-ROM, DVD disc, or a disc recording medium such as a Blu-ray disc. Further, the auxiliary storage unit 330 may be a removable medium (portable storage medium).

Examples of the removable medium include a USB memory or an SD card. The communication I/F 340 is, for example, a Local Area Network (LAN) interface board or wireless communication circuitry for wireless communication.

In the server 300, an operating system (OS), various programs, various information tables, and the like are stored in the auxiliary storage unit 330. Further, in the server 300, the processor 310 loads the program stored in the auxiliary storage unit 330 into the main storage unit 320 and executes the program, thereby realizing various functions as described later. However, some or all of the functions of the server 300 may be implemented by hardware circuitry such as ASIC or FPGA. Note that the server 300 does not necessarily have to be realized by a single physical configuration, and may be constituted by a plurality of computers that cooperate with each other.

### Functional Configuration

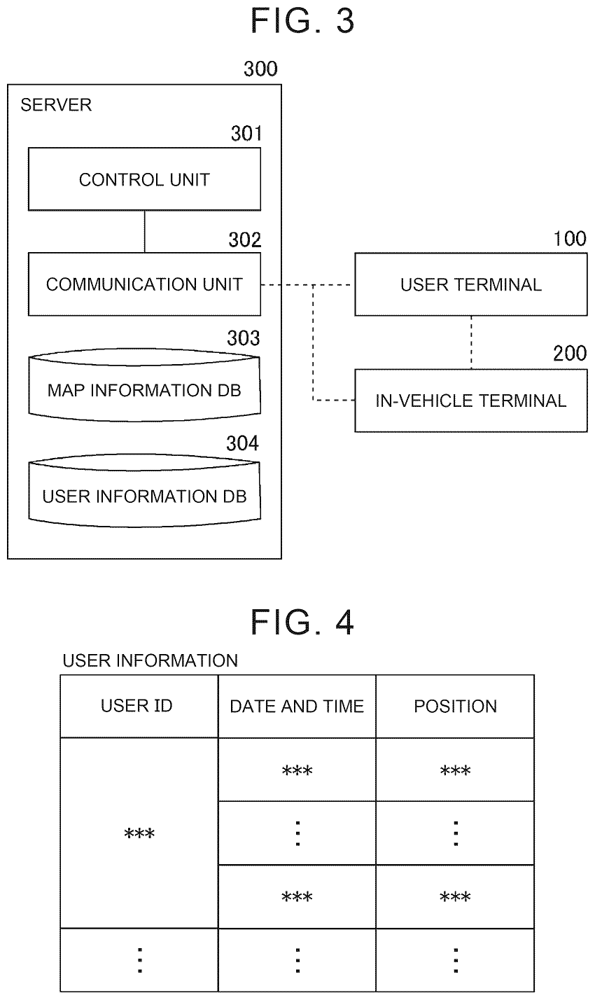

Next, a functional configuration of the server 300 constituting the position specifying system 1 according to the present embodiment will be described with reference to FIG. 3 to FIG. 4. FIG. 3 is a block diagram schematically illustrating an example of a functional configuration of the server 300. The server 300 is configured to include a control unit 301, a communication unit 302, a map information database 303 (facility information DB 303), and a user information database 304 (user information DB 304).

The control unit 301 has a function of performing arithmetic processing for controlling the server 300. The control unit 301 can be realized by the processor 310 in the server 300. The communication unit 302 has a function of connecting the server 300 to a network N1. The communication unit 302 can be realized by a communication I/F 340 in the server 300.

The facility information DB 303 has a function of holding map information. The facility-information DB 303 can be realized by the auxiliary storage unit 330 in the server 300. The map information is map information about the inside of a plurality of buildings including a specific building. The map information includes information on the position and the like of an internal structure such as a wall or a column in a building.

The control unit 301 receives position information indicating the current position of the vehicle 20 from each in-vehicle terminal 200 via the communication unit 302. Then, the control unit 301 refers to the position information received from each in-vehicle terminal 200 and the map information held in the facility information DB 303, and calculates the intensity distribution of the radio waves outputted by each in-vehicle terminal 200 in the specified building.

Here, the control unit 301 calculates the intensity distribution of the radio waves for each in-vehicle terminal 200 in real time. That is, the control unit 301 receives the position information from each in-vehicle terminal 200 in real time, and calculates the intensity distribution of the real-time radio waves in the specific building. As described above, by calculating the intensity distribution of the radio waves in the specific building in real time, it is possible to calculate the intensity distribution in the specific building that varies depending on the arrangement of the plurality of vehicles 20. That is, the intensity distribution of the radio wave that changes as the vehicle 20 moves can always be grasped. As a result, even if the vehicle 20 is moving, the intensity distribution of the radio waves in the specific building can be calculated.

In addition to the current position of the vehicle 20, the control unit 301 may acquire, from the in-vehicle terminal 200, a position of an antenna for outputting a radio wave for short-range communication in the vehicle 20 (in-vehicle terminal 200). In this case, the control unit 301 calculates the intensity distribution of the radio wave output from the in-vehicle terminal 200 in consideration of the position of the antenna in the vehicle 20. Specifically, for example, when the antenna in the vehicle 20 is located in front of the vehicle 20, the control unit 301 shifts the output source of the radio wave to the front of the vehicle 20 to calculate the intensity distribution.

Further, the control unit 301 may acquire information indicating the vehicle type or the like of the vehicle 20 and calculate the intensity distribution of the radio wave output by the in-vehicle terminal 200 in consideration of the vehicle type or the like of the vehicle 20. In these cases, the control unit 301 calculates the intensity distribution of the radio waves output from the in-vehicle terminal 200 in consideration of, for example, an output amount of the radio waves for each vehicle type recorded in advance.

Further, the control unit 301 receives the reception intensity information from the user terminal 100 via the communication unit 302. Then, the control unit 301 refers to the calculated intensity distribution and reception intensity information of the radio waves output from each in-vehicle terminal 200, and identifies the area in which the user 10 is present. Specifically, the control unit 301 specifies an area in which the intensity distribution of the radio wave output from each in-vehicle terminal 200 and the reception intensity of the radio wave output from each in-vehicle terminal 200 received by the user terminal 100 correspond to each other. Then, the control unit 301 identifies the identified area as the current position of the user 10.

At this time, a plurality of areas may be identified as areas where the user 10 exists. In this case, the control unit 301 further specifies the area in which the user 10 exists by using the position information indicating the current position measured by the user terminal 100 received from the user terminal 100. Specifically, the control unit 301 identifies, as the current position of the user 10, an area closest to the current position of the user terminal 100 indicated by the position information received from the user terminal 100.

Upon specifying the present position of the user 10, the control unit 301 updates the user information held in the user information DB 304. The user information is information about the current position of the identified user 10. The user information DB 304 can be realized by the auxiliary storage unit 330 in the server 300. FIG. 4 is a diagram illustrating an exemplary table configuration of user information held in the user information DB 304. As illustrated in FIG. 4, the user data includes a user ID field, a date and time field, and a position field.

In the user ID field, an identifier (user ID) for identifying the user 10 is stored. When the server 300 manages the present positions of a plurality of users 10, a plurality of user ID are stored. In the date and time field, information indicating the date and time when the control unit 301 has specified the current position of the user 10 is stored. In the position field, the current position of the user 10 specified by the control unit 301 at the date and time when the current position of the user 10 is specified is input. In the location field, information indicating the identified area is stored. Here, the information indicating the identified area is, for example, information indicating a latitude and longitude range of the area. Further, the information indicating the specified area may be, for example, information indicating latitude, longitude, and the like of a point (for example, a center of gravity, or the like) representing the area.

The control unit 301 can grasp the present position of the user 10 that has been specified in the past by acquiring the user information held in the user information DB 304.

Further, the control unit 301 determines whether or not the user 10 and the vehicle 20 are within a predetermined distance. Specifically, the control unit 301 refers to the specified current position of the user 10 and the current position of the vehicle 20 indicated by the position information received from the in-vehicle terminal 200, and determines whether or not these current positions exist within a predetermined distance. When determining that the identified current position of the user 10 and the acquired current position of the vehicle 20 exist within a predetermined distance, the control unit 301 generates notification information. Then, the control unit 301 causes the communication unit 302 to transmit (output) the notification information to the user terminal 100 and the in-vehicle terminal 200. This makes it possible to prompt the user 10 to pay attention to the vehicle 20 existing in the surroundings. In addition, the vehicle 20 can be prompted to pay attention to the user 10 existing in the surroundings.

Note that the control unit 301 may determine whether or not the user 10 and the vehicle 20 are present within a predetermined distance in the future in consideration of the traveling speed of the vehicle 20 and the traveling direction of the vehicle 20. Specifically, the control unit 301 receives the traveling speed and the traveling direction of the vehicle 20 from the in-vehicle terminal 200 via the communication unit 302. In a case where it is determined that the user 10 and the vehicle 20 are present within a predetermined distance within a predetermined time, the control unit 301 may generate and transmit notification information. Here, the predetermined time is a time set in advance as a time during which the vehicle 20 can be expected to move. The predetermined time may be determined according to, for example, the traveling speed of the vehicle 20. Accordingly, when it is predicted that the user 10 and the vehicle 20 will be within a predetermined distance in the future, it is possible to prompt the user to pay attention to both of them.

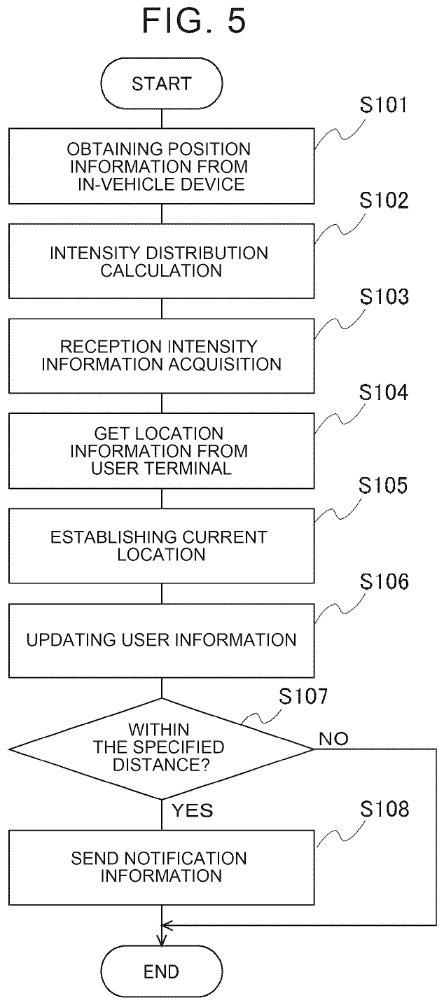

Further, the predetermined time may be a time required from the start of the execution of the process for specifying the current position of the user 10 (the process illustrated in FIG. 5) until the notification information is output. Accordingly, the notification information can be transmitted to the user 10 and the vehicle 20 in consideration of the position of the vehicle 20 that changes during the execution of the process for specifying the current position of the user 10.

Further, the control unit 301 may further consider the moving speed and the moving direction of the user 10 to determine whether or not the user 10 and the vehicle 20 are present within a predetermined distance in the future. In this situation, the control unit 301 acquires, for example, the transition of the present position of the user 10 in the user information held in the user information DB 304. Thus, the control unit 301 can estimate the moving speed and the moving direction of the user 10. As a result, the control unit 301 can determine whether or not the user 10 and the vehicle 20 will be within a predetermined distance in the future, in consideration of the moving speed and the moving direction of the user 10.

### Flowchart

Next, a process executed by the control unit 301 in the server 300 in the position specifying system 1 will be described with reference to FIG. 5. FIG. 5 is a flowchart of processing executed by the control unit 301. This process is a process for specifying the current position of the user 10. The process is a process of transmitting notification information when the user 10 and the vehicle 20 are within a predetermined distance. The processing is repeatedly executed at predetermined intervals so that the current position of the user 10 can be grasped in real time.

In the process illustrated in FIG. 5, first, position data transmitted from a plurality of in-vehicle terminals 200 is acquired in S101. Next, in S102, the location information received from the plurality of in-vehicle terminals 200 and the map information held in the facility information DB 303 are referred to, and the intensity distribution of the radio waves in the specified building is calculated. Next, in S103, the reception strength data transmitted from the user terminal 100 is acquired. Next, in S104, the location data transmitted from the user terminal 100 is acquired. Next, in S105, the present position of the user 10 is identified.

As described above, in the process illustrated in FIG. 5, by calculating the intensity distribution of the radio waves in the specific building and specifying the current position of the user 10 each time, the current position of the user 10 can be specified while taking into consideration the change in the intensity distribution of the radio waves caused by the movement of the vehicle 20.

Next, in S106, the user information held in the user information DB 304 is updated. Next, in S107, it is determined whether or not the current position of the user 10 and the current position of the vehicles 20 are within a predetermined range. Specifically, the control unit 301 determines whether or not the vehicle is present within a predetermined distance from the current position of the user 10 among the current positions of the plurality of vehicles 20 existing in the specific building.

If an affirmative determination is made in S107, there is a risk that the user 10 and the vehicle 20 are present within a predetermined range. Therefore, in S108, the notification is transmitted to the user terminal 100 and the in-vehicle terminal 200. Then, the processing illustrated in FIG. 5 is temporarily ended.

As a result, the notification information is output to the user 10 in the user terminal 100. In addition, the in-vehicle terminal 200 outputs notification information to the driver of the vehicle 20 or the like. As a result, the user 10 and the vehicle 20 can pay attention to each other. In addition, the electronic control unit of the vehicle 20 may control the traveling state of the vehicle 20 by transferring the notification information to the electronic control unit that controls the traveling of the vehicle 20 by the in-vehicle terminal 200. In this case, since the notification information includes the current position of the user 10, the travel control unit of the vehicle 20 may grasp the current position of the user 10 and then perform the travel control so as to make the travel safe.

When a negative determination is made in S107, there is no risk of danger due to the presence of the user 10 and the vehicle 20 within a predetermined range. Therefore, the process illustrated in FIG. 5 is temporarily ended.

As described above, in the position specifying system 1, even when the current position that the user terminal 100 can acquire by GPS system becomes inaccurate, the accurate current position of the user 10 can be grasped by using the intensity distribution and the reception intensity.

### First Modification

In the present embodiment, when a plurality of areas is identified as an area where the user 10 exists, the control unit 301 further identifies the area where the user 10 exists by using the position information indicating the current position of the user 10 received from the user terminal 100.

Here, the processing illustrated in FIG. 5 is repeatedly executed at predetermined intervals so that the current position of the user 10 can be grasped in real time. Therefore, it is assumed that the current position of the user 10 is not moved significantly compared to the case where the processing shown in FIG. 5 is executed last time. Therefore, the control unit 301 refers to the current position of the user 10 in the user information held in the user information DB 304, and further identifies the area in which the user 10 exists.

That is, the control unit 301 executes a process of acquiring the user information from the facility information DB 303 instead of S104 process in the process illustrated in FIG. 5. At this time, the control unit 301 uses the current position of the latest user 10 in the user information in place of the current position of the user 10 indicated by the position information received from the user terminal 100. Even in this manner, it is possible to grasp an accurate current position of the user 10.

When the control unit 301 executes the processing illustrated in FIG. 5 for the first time, a plurality of areas may be specified as the area where the user 10 exists. Further, in the subsequent processing, a plurality of areas may be specified as the area where the user 10 exists. In this case, the control unit 301 may identify all of the plurality of areas as the provisional current position of the user 10, and repeat the processing illustrated in FIG. 5.

Note that the control unit 301 may repeat the execution of the processing illustrated in FIG. 5 without specifying the current position of the user 10 until the area where the user 10 exists is specified as one. In addition, the control unit 301 may receive the position information from the user terminal 100 only for the first time and specify the position of the user 10.

### Second Modification

In the present embodiment, the server 300 identifies the current position of the user 10 by referring to the reception intensity of the user terminal 100 in the specific building and the intensity distribution of the radio waves by the plurality of in-vehicle terminals 200. However, even when the user terminal 100 and the in-vehicle terminal 200 are places where the user terminal 100 cannot receive GPS radio wave and cannot acquire the present position of the user terminal 100 but is not a particular building, the present embodiment can be applied. The present embodiment can be applied even when the user terminal 100 does not include GPS device in the user terminal 100.

### Modification 3

In the present embodiment, the user terminal 100 is a portable information terminal used by the user 10. However, the present embodiment can also be applied to a case where the user terminal 100 is, for example, an in-vehicle terminal mounted on a vehicle used by the user 10. In this case, the vehicle used by the user 10 is, for example, a vehicle that cannot be used by GPS device.

### Modification 4

In the present embodiment, the server 300 executes the processing illustrated in FIG. 5. However, the server 300 does not necessarily have to execute the processing illustrated in FIG. 5. For example, the user terminal 100 or the in-vehicle terminal 200 may execute some or all of the processing illustrated in FIG. 5.

### Other Embodiments

The above-described embodiments are mere examples, and the present disclosure can be implemented with appropriate modifications within a range not departing from the scope thereof. Moreover, the processes and units described in the present disclosure can be freely combined and implemented unless technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. Examples of the non-transitory computer-readable storage medium include a random disk (such as a magnetic disk (a floppy (registered trademark) disk an HDD, and the like) or an optical disc (such as a CD-ROM, a DVD disc, and a Blu-ray disc)), a ROM, a RAM, an EPROM, an EEPROM, a magnetic card, a flash memory, an optical card, and a random type of medium suitable for storing electronic instructions.

What is claimed is:

1. An information processing device comprising a control unit configured to:
acquire a present position of a plurality of vehicles;
estimate an intensity distribution of a radio wave output by each of the vehicles according to the present position of the vehicles;
acquire a reception intensity of the radio wave output by each of the vehicles and received by a terminal that moves together with a user; and
specify a position corresponding to the intensity distribution and the reception intensity as a present position of the user.

2. The information processing device according to claim 1, wherein:
the control unit is further configured to acquire a present position of the terminal measured by the terminal; and
the specifying of a position corresponding to the intensity distribution and the reception intensity as a present position of the user includes specifying, when there are a plurality of positions corresponding to the intensity distribution and the reception intensity, a position that is closest to the present position of the terminal measured by the terminal as the present position of the user.

3. The information processing device according to claim 1, wherein:
the control unit is further configured to store information that indicates the specified present position of the user; and
the specifying of a position corresponding to the intensity distribution and the reception intensity as a present position of the user includes specifying, when there are a plurality of positions corresponding to the intensity distribution and the reception intensity, a position that is closest to a latest specified present position of the user as the present position of the user.

4. The information processing device according to claim 1, wherein the control unit is further configured to output, when the user and at least one of the vehicles are present within a predetermined distance, information that notifies the terminal that the vehicle is present around the user.

5. The information processing device according to claim 1, wherein the control unit is further configured to output, when the user and at least one of the vehicles are present within a predetermined distance, information that notifies the vehicle that the user is present around the vehicle.
